(19) United States
(12) Patent Application Publication
(10) Pub. No.: US 2024/0201418 A1
(43) Pub. Date: Jun. 20, 2024

(54) MARINE MONITORING SYSTEM, CONTROL APPRATUS AND MARINE MONITORING METHOD

(71) Applicant: Nippon Telegraph and Telephone Corporation, Tokyo (JP)

(72) Inventors: Go ITAMI, Musashino-shi, Tokyo (JP); Jun KATO, Musashino-shi, Tokyo (JP)

(21) Appl. No.: 18/555,288

(22) PCT Filed: Apr. 15, 2021
(86) PCT No.: PCT/JP2021/015604

§ 371 Date: Oct. 13, 2023

(51) Int. Cl. G01W 1/04; B63B 35/44; B63B 35/50; B63B 79/15; B64U 10/60; B64U 50/35; B64U 101/00; G05D 1/678; G05D 105/80; G05D 107/00; G05D 109/25

(52) U.S. Cl. CPC G01W 1/04; B63B 35/50; B63B 79/15; B64U 10/60; B64U 50/35; G05D 1/678; B63B 2035/4453; B64U 2101/00; B64U 2201/202; G05D 2105/80; G05D 2107/27; G05D 2109/254

(57) ABSTRACT

A marine monitoring system includes a control device 1 and at least one flight vehicle 2. The control device 1 includes: a sensor unit 13 that measures at least one of an underwater environment and a sea-surface environment to acquire marine data; a control unit 16 that controls the flight vehicle 2; and a communication unit 15 that receives above-water data measured by the flight vehicle 2. The flight vehicle 2 includes a sensor unit 24 that measures an above-water environment according to control of the control device 1 to acquire the above-water data, and a communication unit 21 that transmits the above-water data to the control device 1.

### TECHNICAL FIELD

The present invention relates to a marine monitoring system, a control device, and a marine monitoring method.

### BACKGROUND ART

Satellite remote sensing is performed in global environment monitoring. Satellite remote sensing is a method of sensing the earth from a communication satellite equipped with a sensor. As a result, it is possible to grasp the ground surface, the forest logging damage situation, the ozone hole, the cloud, the aerosol, the spatial distribution and the temporal transition of harmful gas (e.g., NO2 and SO2), and the like.

On the other hand, environmental monitoring on the earth is also performed, and the atmospheric environment is observed on the basis of periodic actual data concerning air pollution, CO2 concentration, temperature, and humidity, for example.

Additionally, environmental monitoring in the ocean is also performed, and fixed point observation using a ship or a buoy, observation in a wide range using a sea current, measurement of the temperature in the sea in a deep part by changing the density of the buoy, and the like are performed (Non Patent Literature 1).

### CITATION LIST

### Non Patent Literature

Non Patent Literature 1: Masaaki Wada, Hideyuki Nakashima, “IT niyoru gyogyousaisei (Recovery of fishery by IT)”, 2015, online, the Internet <URL: https://www.kantei.go.jp/jp/singi/it2/region/sewg_dai2/shir you5.pdf>

### SUMMARY OF INVENTION

### Technical Problem

In marine environment monitoring, by combining underwater and sea-surface environmental data with above-water environmental data (atmospheric environment data), it can be expected that spatial and temporal completeness of data is secured and reliability is enhanced. That is, more advanced marine environment monitoring can be achieved.

However, in marine environment monitoring using a ship, a buoy, or the like, it is possible to measure the underwater or sea-surface environment, but it is difficult to sense the above-water surrounding environment with a certain degree of freedom.

The present invention has been made in view of the above circumstances, and an object of the present invention is to provide a technology capable of monitoring not only the underwater or sea-surface environment but also the above-water environment.

### Solution to Problem

In order to achieve the above object, one aspect of the present invention is a marine monitoring system including a control device and at least one flight vehicle. The control device includes: a first measurement unit that measures at least one of an underwater environment and a sea-surface environment to acquire first measurement data; a control unit that controls the flight vehicle; and a first communication unit that receives second measurement data measured by the flight vehicle. The flight vehicle includes: a second measurement unit that measures an above-water environment according to control of the control device to acquire the second measurement data; and a second communication unit that transmits the second measurement data to the control device.

One aspect of the present invention is a control device in a marine monitoring system including a control device and at least one flight vehicle. The control device includes: a measurement unit that measures at least one of an underwater environment and a sea-surface environment to acquire first measurement data; a control unit that controls the flight vehicle that measures an above-water environment; and a communication unit that receives second measurement data measured by the flight vehicle from the flight vehicle.

### Advantageous Effects of Invention

According to the present invention, it is possible to provide a technology capable of monitoring not only the underwater or sea-surface environment, but also the above-water environment.

### BRIEF DESCRIPTION OF DRAWINGS

FIG. 1 is an overall configuration diagram illustrating a configuration of a marine monitoring system of the present embodiment.

FIG. 2 is a configuration diagram illustrating a configuration of a flight vehicle of the present embodiment.

FIG. 3 is an external view illustrating an example of an external appearance of a control device.

FIG. 4 is a cross-sectional view of the control device illustrated in FIG. 3.

FIG. 5 is an explanatory diagram illustrating communication between the control device and the flight vehicle.

FIG. 6 is an explanatory diagram illustrating recovery of a flight vehicle.

FIG. 7 is an explanatory diagram illustrating power supply to a flight vehicle.

FIG. 8 is an explanatory diagram illustrating data transmission to a communication satellite.

FIG. 9 is an explanatory diagram illustrating power generation by the control device.

FIG. 10 is a flowchart illustrating data transmission processing by the control device.

FIG. 11 is a flowchart illustrating above-water data transmission processing by the flight vehicle 2.

FIG. 12 is a hardware configuration example.

### DESCRIPTION OF EMBODIMENTS

Hereinafter, an embodiment of the present invention will be described with reference to the drawings.

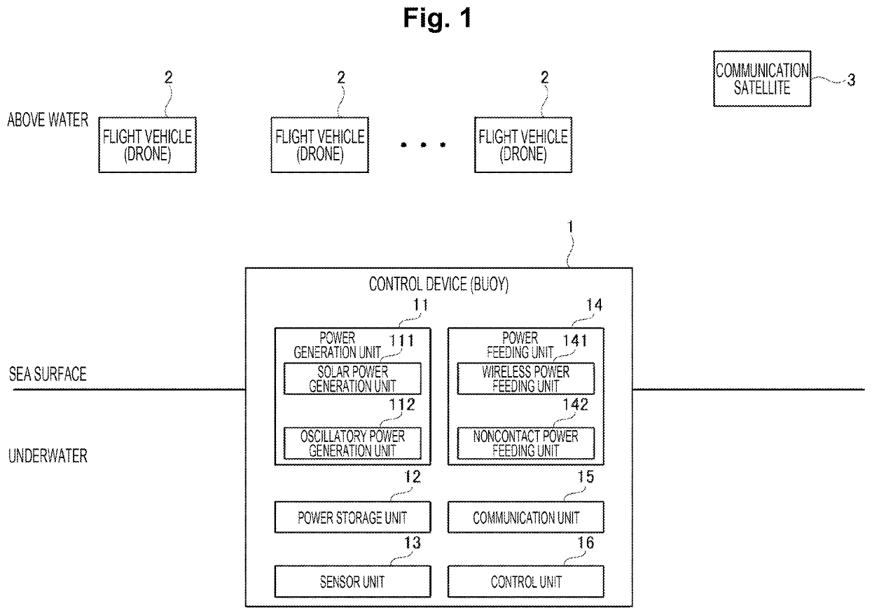

FIG. 1 is a configuration diagram illustrating a configuration of a marine monitoring system of the present embodiment. The illustrated marine monitoring system includes a control device 1 and at least one flight vehicle 2.

The control device 1 is disposed in the sea, measures at least one of the underwater environment and the sea-surface environment, and remotely controls the flight vehicle 2. As the control device 1, for example, a buoy, a float, a ship, or the like may be used. The control device 1 may be a moored and non-moving device or a movable device having moving means.

At least one flight vehicle 2 is assigned to the control device 1, and the control device 1 controls one or more flight vehicles 2. It is assumed that the control device 1 of the present embodiment controls a plurality of flight vehicles 2.

The control device 1 illustrated in FIG. 1 includes a power generation unit 11, a power storage unit 12, a sensor unit 13, a power feeding unit 14, a communication unit 15, and a control unit 16.

The power generation unit 11 includes a solar power generation unit 111 using solar energy and an oscillatory power generation unit 112 using oscillation of waves. The solar power generation unit 111 is disposed above the sea surface so as to receive sunlight.

The power storage unit 12 stores power generated by the power generation unit 111 and the oscillatory power generation unit 112. The control device 1 and the flight vehicle 2 are driven by using power stored in the power storage unit 12.

The sensor unit 13 (first measurement unit) measures (senses) at least one of the above-water environment and the sea-surface environment to acquire marine data (first measurement data). The sensor unit 13 includes one or a plurality of sensors. The sensor unit 13 may include a plurality of sensors of different types. The marine data includes, for example, water temperature, water pressure, salinity, and the like. The sensor unit 13 can be dispersedly arranged at an arbitrary position (e.g., above sea surface or below sea surface) of the control device 1 according to the object to be measured.

The power feeding unit 14 supplies power of the power storage unit 12 to the flight vehicle 2. Specifically, the power feeding unit 14 feeds power to a flying flight vehicle 2 by radio wave transmission, and feeds power to a flight vehicle on standby in the control device 1 in a contactless manner. That is, the power feeding unit 14 includes a wireless power feeding unit 141 that feeds power to the flying flight vehicle 2 by radio wave transmission, and a noncontact power feeding unit 142 that feeds power to the standby flight vehicle 2 in a contactless manner.

The communication unit 15 (first communication unit) communicates with the flight vehicle 2 and a communication satellite 3 in accordance with an instruction from the control unit 16. For example, the communication unit 15 receives above-water data measured by the flight vehicle 2, and sends the received above-water data to the control unit 16. The communication unit 15 transmits control information instructed by the control unit 16 to the flight vehicle 2. The communication unit 15 may communicate with the communication satellite 3 and transmit marine data measured by itself and the above-water data received from the flight vehicle 2 to the communication satellite 3.

The control unit 16 controls each of the units 11 to 15 of the control device 1. The control unit 16 transmits control information to the flight vehicle 2 using the communication unit 15 to control the flight vehicle 2. Control information is information for controlling and operating the flight vehicle 2. Control information includes, for example, a flight instruction indicating a flight path of the flight vehicle 2, a return instruction for returning the flight vehicle 2 to the control device 1, and the like.

In a case where the control device 1 and the flight vehicle 2 are connected by a wire, the control unit 16 may control the flight vehicle 2 or an adjustment unit included in the control device 1 to shorten the length of the open portion of the wire, thereby recovering the flight vehicle 2 to the control device 1. The adjustment unit will be described later.

The control unit 16 controls the sensor unit 13 to cause the sensor unit 13 to measure marine data at an arbitrary timing. The control unit 16 acquires measured marine data and stores the acquired marine data in a storage device included in the control unit 16.

Note that the control unit 16 may autonomously execute various processes such as control of the flight vehicle 2 and acquisition of marine data using the sensor unit 13, or may execute the various processes in accordance with an instruction from a management device (not illustrated). The management device may be disposed on the ground, for example, and may remotely control the control device 1 by remotely accessing the control device 1 by wireless communication. In this case, the management device can indirectly remotely control the flight vehicle 2 via the control device 1.

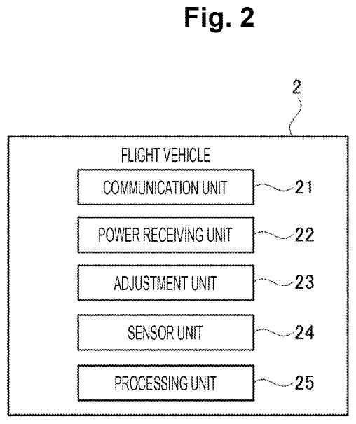

FIG. 2 is a diagram illustrating a configuration of the flight vehicle 2 of the present embodiment. The flight vehicle 2 flies under the control of the control device 1 and measures the above-water environment. The flight vehicle 2 is an unmanned flight vehicle, and a drone or the like can be used, for example.

The illustrated flight vehicle 2 includes a communication unit 21, a power receiving unit 22, an adjustment unit 23, a sensor unit 24, and a processing unit 25.

The communication unit 21 (second communication unit) communicates with the control device 1. For example, the communication unit 21 receives control information transmitted by the control device 1, and transmits above-water data measured by the sensor unit 24 to the control device 1. The communication unit 21 may communicate with the communication satellite 3 and directly transmit the marine data measured by the sensor unit 24 to the communication satellite 3.

The power receiving unit 22 receives power supplied from the control device 1, and drives the flight vehicle 2 using the power.

In a case where the control device 1 and the flight vehicle 2 are connected by a wire, the adjustment unit 23 adjusts the length of the open portion of the wire according to the control of the control device 1. While the flight vehicle 2 includes the adjustment unit 23 in the present embodiment, the control device 1 may include the adjustment unit 23.

The sensor unit 24 (second measurement unit) measures the above-water environment (atmospheric environment) according to the control of the control device 1, and acquires above-water data (second measurement data). The sensor unit 24 includes one or a plurality of sensors. The sensor unit 24 may include a plurality of sensors of different types. Above-water data includes, for example, temperature, humidity, carbon dioxide concentration, and the like in the atmosphere.

The processing unit 25 drives the flight vehicle 2 according to the control of the control device 1. For example, the processing unit 25 flies the flight vehicle 2 in accordance with control information transmitted by the control device 1, and causes the sensor unit 24 to measure above-water data.

As described above, the marine monitoring system of the present embodiment combines the control device 1 that senses at least one of the underwater and sea-surface marine environments, and the flight vehicle 2 that senses the above-water environment. As a result, in the present embodiment, underwater and above-water marine data and above-water data of the surrounding environment can be used in association with each other and complemented with each other, and spatial and temporal completeness of the data can be secured to enhance reliability. That is, more advanced marine environment monitoring can be achieved.

Additionally, in the present embodiment, the control device 1 that relatively easily generates power and stores power controls and manages the flight vehicle 2, thereby extending the driving time of the flight vehicle 2 and enabling collection of wide-range above-water surrounding information that is difficult to acquire by the control device 1.

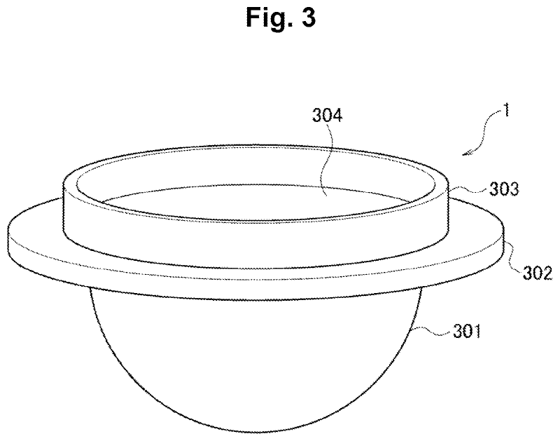

FIG. 3 is an external view illustrating an example of an external appearance of the control device 1. The illustrated control device 1 includes a hemispherical lower layer part 301, a columnar middle layer part 302, and a columnar (tubular) upper layer part 303 having a recess 304. The recess 304 is a standby area where at least one flight vehicle 2 can stand by. Here, the lower layer part 301 is located in the sea, and the middle layer part 302 and the upper layer part 303 are located above the sea surface. The control device 1 is not limited to the shape of FIG. 3, and may have various other shapes.

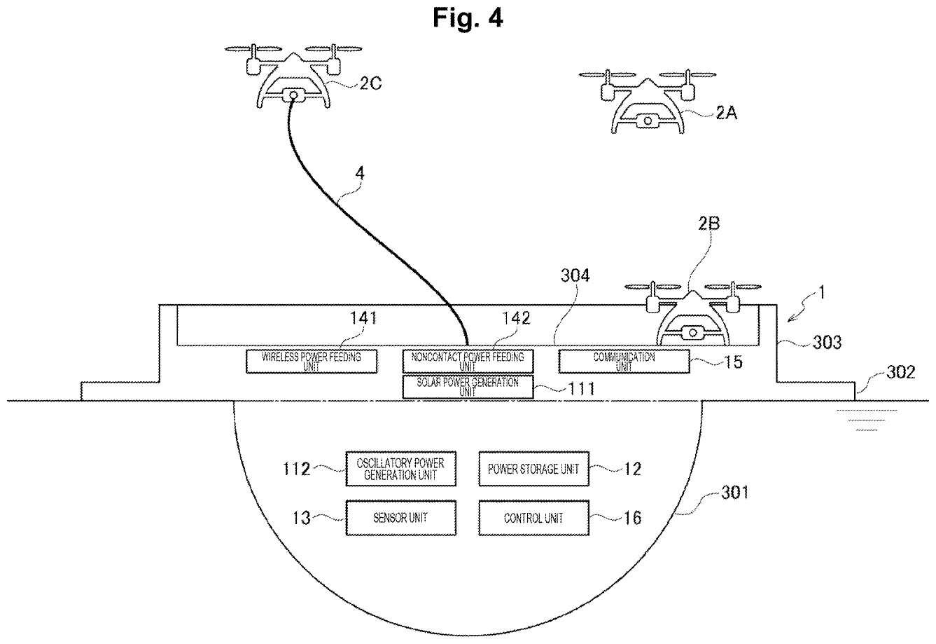

FIG. 4 is a cross-sectional view of the control device 1 illustrated in FIG. 3. In the illustrated control device 1, the solar power generation unit 111, the wireless power feeding unit 141, the noncontact power feeding unit 142, and the communication unit 15 are disposed in the middle layer part 302 and the upper layer part 303 located above the sea surface. The oscillatory power generation unit 112, the power storage unit 12, the sensor unit 13, and the control unit 16 are disposed in the lower layer part 301 in the sea. FIG. 4 is an example of the control device 1, and the arrangement of each unit is not limited thereto. FIG. 4 illustrates a flight vehicle 2A in flight, a flight vehicle 2B on standby in a standby area 304, and a flight vehicle 2C in flight connected to the control device 1 by a wire 4.

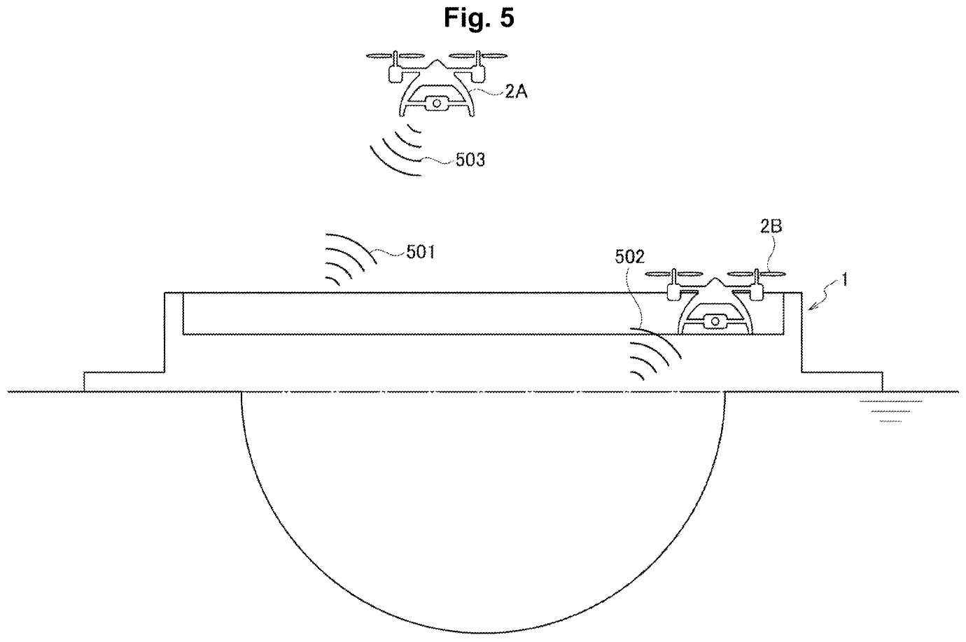

FIG. 5 is an explanatory diagram illustrating communication between the control device 1 and the flight vehicle 2. In response to an instruction from the control unit 16, the communication unit 15 of the control device 1 transmits control information 501 and 502 for controlling the flight vehicle 2 to the flight vehicles 2A and 2B, and receives above-water data 503 measured by the flight vehicle 2A from the flight vehicle 2. As a result, the control device 1 can operate the flight vehicles 2A and 2B.

In the illustrated example, the communication unit 15 transmits, as the control information 501, for example, an additional flight program, a flight instruction such as a command to return to the control device 1, an acquisition instruction of above-water data, and the like to the flight vehicle 2A in flight. Additionally, the communication unit 15 stands by in the control device 1, and transmits, for example, a flight instruction such as a flight program, an acquisition instruction of above-water data, and the like as the control information 502 to the flight vehicle 2B scheduled to fly from now. The flight vehicle 2A transmits above-water data 503 indicating the measured above-water atmospheric environment to the control device 1. The communication unit 15 of the control device 1 receives the above-water data 503 transmitted by the flight vehicle 2A.

While one flight vehicle 2A is in flight in FIG. 5, the communication unit 15 can receive above-water data transmitted by each of a plurality of flight vehicles 2A. Additionally, the communication unit 15 can receive a plurality of different types of data transmitted from the flight vehicle 2A. The control unit 16 may store the above-water data received by the communication unit 15 in a memory or the like included in the control unit 16 and store the above-water data as backup data until the above-water data is transmitted to the communication satellite 3.

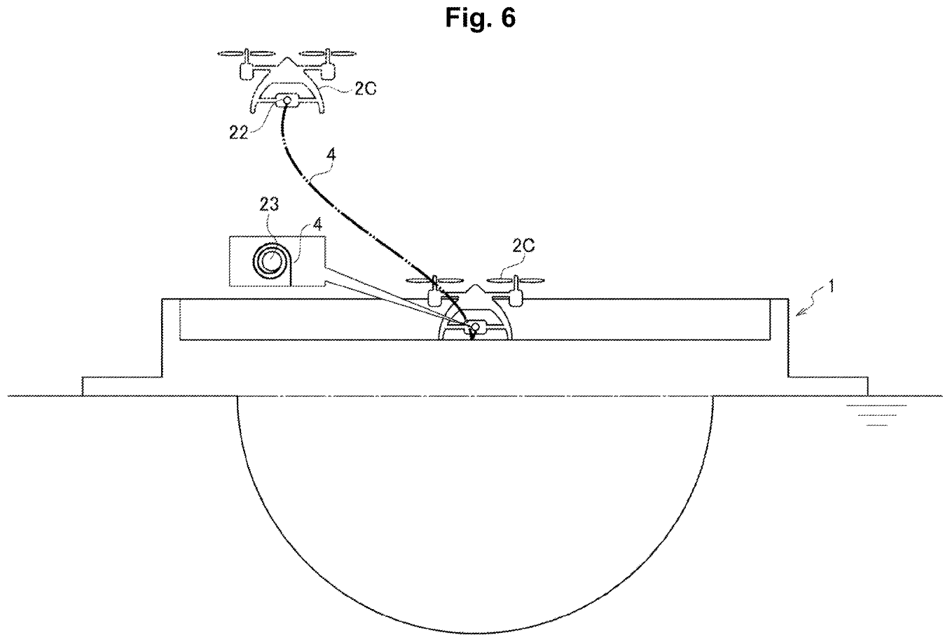

FIG. 6 is an explanatory diagram illustrating recovery of the flight vehicle 2. Here, the control device 1 and the flight vehicle 2 are connected by a wire such as the wire 4 (metal wire). The flight vehicle 2 includes an adjustment unit 23 (wire reel) that adjusts the length of the open portion of the wire 4. When the flight vehicle 2 flies, the adjustment unit 23 adjusts the length of the open portion of the wire 4 in accordance with the distance between the control device 1 and the flight vehicle 2. The open portion is adjusted to be longer than the distance between the control device 1 and the flight vehicle 2, which is the length of the wire 4 of the portion not wound by the adjustment unit 23.

When transmitting a flight command to the flight vehicle 2, the control unit 16 of the control device 1 controls the adjustment unit 23 so that the flight vehicle 2 can fly according to the flight command. For example, when flying the flight vehicle 2 far from the control device 1, the control unit 16 instructs the adjustment unit 23 to pull out the wire 4 having a necessary length from the adjustment unit 23.

Additionally, when the control device 1 recovers the flight vehicle 2, the control unit 16 instructs the adjustment unit 23 to wind the wire 4 so that the length of the open portion of the wire 4 is shortened. As a result, the control unit 16 can return the flight vehicle 2 in flight to the control device 1. Additionally, since the flight vehicle 2 is connected to the control device 1 by the wire 4, even if the flight vehicle 2 fails during flight and stops, the flight vehicle 2 can be recovered to the standby area of the control device 1 by winding the wire 4.

Additionally, when the wire 4 is entangled in the air, the control device 1 can also detect an abnormality of the flight vehicle 2, disconnect the wire 4, identify the position information of the flight vehicle 2 from the relative positional relationship with the control device 1 at that time, and attach a strong electromagnet to the tip of the wire 4 to recover the flight vehicle 2.

Specifically, when the wire 4 is entangled, the flight vehicle 2 detects an abnormality because the flight instructed by the control device 1 cannot be performed, and notifies the control device 1 of an error message. When receiving the error message, the control device 1 transmits an instruction to disconnect the wire 4 to the flight vehicle 2, and the flight vehicle 2 disconnects the wire 4. As a result, the tip end of the wire 4 disconnected from the flight vehicle 2 falls into the sea. It is assumed that the flight vehicle 2 also falls into the sea in the vicinity of the position where the tip end of the wire 4 falls after the wire 4 is disconnected. The control device 1 may identify the position information of the flight vehicle 2 at the time of receiving the error message from the relative positional relationship with the control device 1, move to a point where the flight vehicle 2 would have fallen into the sea, attach a strong electromagnet to the tip of the wire 4, and recover the flight vehicle 2 using the magnetic force of the electromagnet.

Additionally, the control device 1 can also feed power (wired power supply) to the flight vehicle 2 using the wire 4. That is, the control device 1 may use the wire 4 as the power feeding unit 14.

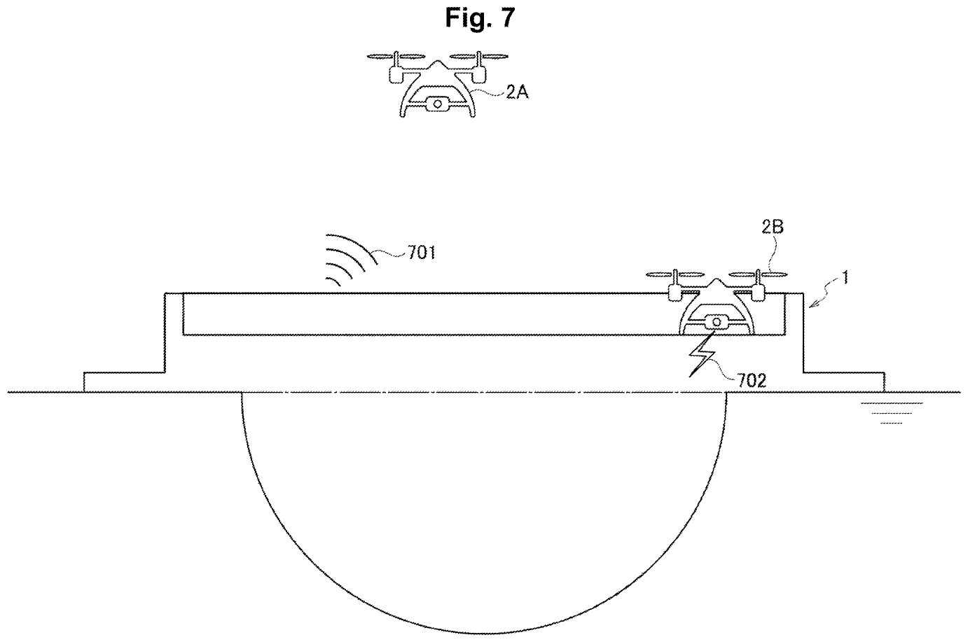

FIG. 7 is an explanatory diagram illustrating power supply to the flight vehicle 2. FIG. 7 illustrates two power feeding methods, that is, wireless power feeding for transmitting radio waves to the flying flight vehicle 2A and contactless power feeding for contactlessly feeding power to the flight vehicle 2B on standby in the control device 1.

The wireless power feeding unit 141 feeds power to the flying flight vehicle 2A using microwaves 701. At this time, the wireless power feeding unit 141 modulates the microwaves for power supply to transmit a signal to the flight vehicle 2 together with power, and can communicate with the flight vehicle 2. That is, the wireless power feeding unit 141 can transmit various types of control information to the flight vehicle 2 simultaneously with power supply.

The noncontact power feeding unit 142 can constantly supply power 702 to the flight vehicle 2B on standby in the control device 1 in a contactless manner using electromagnetic induction, magnetic field resonance, electric field coupling, or the like.

The wireless power feeding unit 141 and the noncontact power feeding unit 142 can simultaneously feed power to the plurality of flight vehicles 2A and 2B. The wireless power feeding unit 141 can simultaneously feed power to a plurality of the flight vehicles 2A by using multi-beam forming, for example. Additionally, by providing a plurality of the noncontact power feeding units 142 in the standby area of the control device 1, it is possible to simultaneously feed power to a plurality of the flight vehicles 2B on standby.

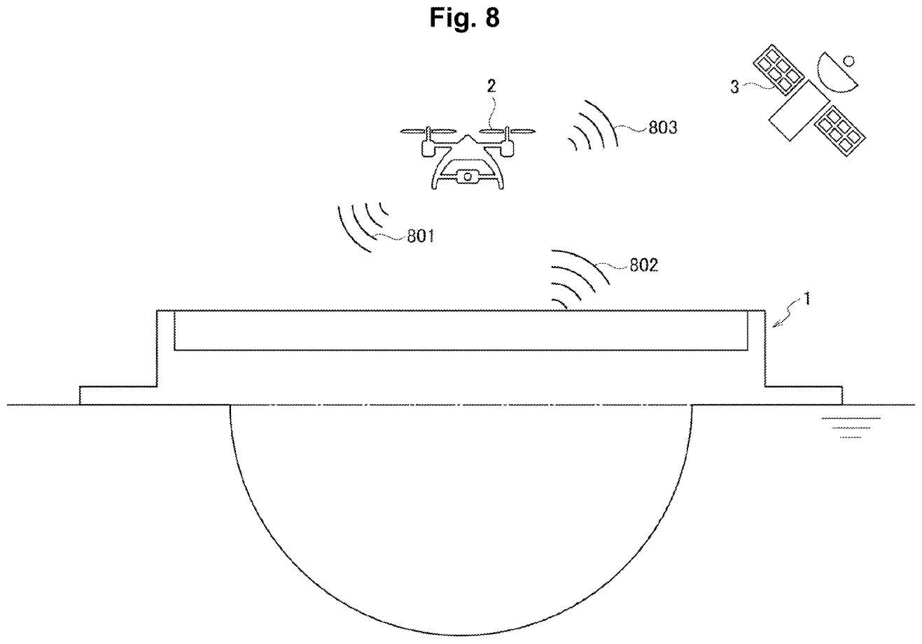

FIG. 8 is an explanatory diagram illustrating data transmission to the communication satellite 3. The communication unit 21 of the flight vehicle 2 transmits above-water data 801 measured by itself to the control device 1. The communication unit 15 of the control device 1 transmits measurement data 802 including marine data measured by itself and the above-water data 801 received from the flight vehicle 2 to the communication satellite 3. That is, the flight vehicle 2 transmits above-water data to the control device 1 at a short distance instead of directly transmitting the above-water data to the communication satellite 3, and the control device 1 collectively transmits marine data and the above-water data to the communication satellite 3.

As a result, power consumption related to communication of the flight vehicle 2 can be curbed, and power that tends to be insufficient can be used for driving related to flight. The flight vehicle 2 can transmit above-water data to the control device 1 regardless of whether it is flying or is on standby in the waiting area.

Note that the communication unit 21 of the flight vehicle 2 may communicate with the communication satellite 3 and directly transmit above-water data 803 to the communication satellite 3. In this case, the control device 1 and the flight vehicle 2 each transmit data measured by itself to the communication satellite 3.

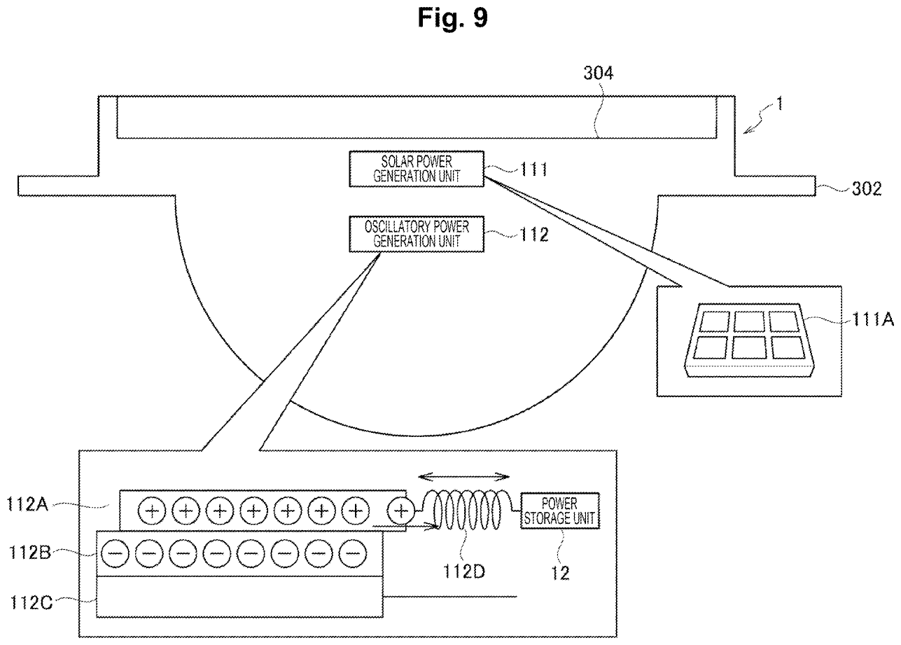

FIG. 9 is an explanatory diagram illustrating power generation by the control device 1. The solar power generation unit 111 is disposed at a position higher than the sea surface and generates power using solar light energy. For example, the solar power generation unit 111 includes a small panel 111A disposed on the outer periphery (middle layer part 302) of the standby area 304. Power obtained by the solar power generation unit 111 during the day is sent to the power storage unit 112.

The oscillatory power generation unit 112 generates power by using oscillation caused by waves. For example, the illustrated oscillatory power generation unit 112 (MEMS oscillatory power generation element) includes a movable electrode 112A, an electret 112B, a fixed electrode 112C, and a spring 112D, and generates power by changing an overlapping area or an interval between the electret 112B and the movable electrode 112A by wave oscillation. The oscillatory power generation unit 112 can constantly generate power because it uses wave oscillation, and the obtained power is sent to the power storage unit 112. The electret 112B is a derivative that holds a semi-permanent charge.

The control device 1 of the present embodiment achieves stable power supply by combining solar power generation that can obtain a relatively large current but is difficult to generate at night with oscillation power generation that can constantly generate power regardless of day and night although the obtained power is not large.

Next, processing of the control device 1 and the flight vehicle 2 of the present embodiment will be described.

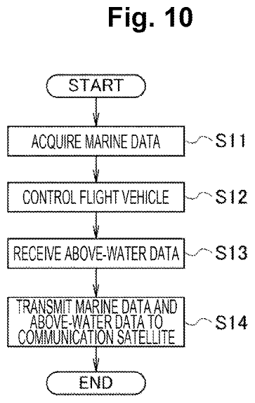

FIG. 10 is a flowchart illustrating data transmission processing by the control device 1. The control device 1 measures at least one of the underwater environment and the sea-surface environment and acquires marine data (step S11). The control device 1 transmits control information to the flight vehicle 2 to control the flight vehicle 2 (step S12). Note that the order of steps S11 and S12 may be reversed. Additionally, steps S11 and S12 may be performed at the same timing. That is, the control device 1 may acquire marine data and control the flight vehicle 2.

The control device 1 receives the above-water data measured by the flight vehicle 2 from the flight vehicle 2 (step S13), and transmits the received above-water data and marine data to the communication satellite 3 (step S14).

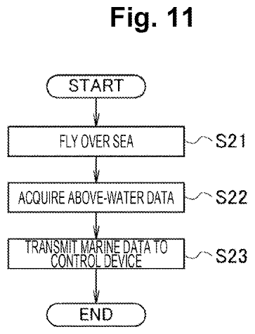

FIG. 11 is a flowchart illustrating above-water data transmission processing by the flight vehicle 2. The flight vehicle 2 receives control information from the control device 1, and flies over the sea according to a flight program designated by the control information (step S21). The flight vehicle 2 measures the above-water environment at a position and timing designated by the control information, and acquires above-water data (step S22). The flight vehicle 2 transmits the measured above-water data to the control device 1 (step S23).

The marine monitoring system of the present embodiment described above includes the control device 1 and at least one flight vehicle 2. The control device 1 includes the sensor unit 13 that measures at least one of the underwater environment and the sea-surface environment to acquire marine data, the control unit 16 that controls the flight vehicle 2, and the communication unit 15 that receives above-water data measured by the flight vehicle 2. The flight vehicle 2 includes the sensor unit 24 that measures the above-water environment according to control of the control device 1 to acquire above-water data, and the communication unit 21 that transmits the above-water data to the control device 1.

As a result, in the present embodiment, it is possible to monitor not only at least one of the underwater environment and the sea-surface environment, but also the above-water environment. Therefore, underwater and sea-surface marine data and above-water data of the surrounding environment can be used in association with each other and complemented with each other, and spatial and temporal completeness of the data can be ensured to enhance reliability and achieve advanced marine environment monitoring.

That is, although it is difficult for the control device 1 alone to acquire above-water data (sensing information) in the vertical direction with respect to the sea surface, it is possible to collect detailed information around the control device 1 including the vertical direction by constructing a continuous system in combination with the flight vehicle 2, and it is possible to collect actual data that cannot be obtained from the communication satellite 3. Hence, it is possible to achieve advancement in both expansion of the data range and high accuracy.

Assuming practical marine sensing, numerous control devices 1 and flight vehicles 2 are required, but in the present embodiment, the control device 1 capable of autonomous operation controls at least one flight vehicle 2, so that the control device 1 and the flight vehicle 2 can be easily managed with less resources.

In the present embodiment, in general, by linking the control device 1 and the flight vehicle 2 having different operation organizations, creation and cooperation systems of secondary industries such as proxy of transportation and recovery of devices (transportation industry, waste collection industry, and the like) and sale and sell-off of energy (energy supply industry) are expected, operation stability as a platform is improved, and an overall economic effect can also be expected. Additionally, problems regarding aging, manpower shortage, and technology succession of fishery workers can also be reduced by assisting work of the fishery workers on the basis of information obtained remotely in the present embodiment.

In the present embodiment, the control device 1 includes the power generation unit 111 and the power feeding unit 112, and drives not only the control device 1 but also the flight vehicle 2. As a result, the driving time of the flight vehicle 2 can be extended, and wide-range information on the above-water surrounding environment which is difficult to acquire by the control device 1 can be collected, whereby sustainability and continuity of collection of above-water data can be secured. Note that in a case where power is fed from the ground to the flight vehicle 2 flying over the sea, the feeding distance is long, the position of the flight vehicle 2 is difficult to grasp, and sufficient and appropriate power feeding is difficult. However, in the present embodiment, the control device 1 disposed in the sea can feed power easily to the flight vehicle 2.

In the present embodiment, the control device 1 and the flight vehicle 2 are connected by the wire 4, the control device 1 or the flight vehicle 2 includes the adjustment unit 23 that adjusts the length of the open portion of the wire 4, and the control unit 16 controls the adjustment unit 23 to shorten the length of the open portion of the wire 4, thereby recovering the flight vehicle 2 to the control device 1. In a case where the flight vehicle 2 is used for marine sensing, there is a high possibility that the flight vehicle 2 is left in the sea when the flight vehicle 2 stops due to battery exhaustion, damage, or the like and cannot be used. However, in the present embodiment, since the flight vehicle 2 can be recovered using the wire 4, it can be said that the system of the present embodiment is a system in consideration of environmental protection.

In the present embodiment, the communication unit 15 of the control device 1 transmits marine data and above-water data received from the flight vehicle 2 to the communication satellite 3. By combining satellite data with above-water data and marine data, it can be expected to secure spatial and temporal coverage and high reliability of data. That is, by linking an autonomous sensor network that is constructed with the concept of the Internet of Things (IOT) and can be placed anywhere on the earth with a satellite remote sensing technology, sensing can be advanced further as a technology for monitoring the entire globe. That is, it is possible to create high-added-value monitoring information by combining and linking information transmitted from the control device 1 and satellite data.

For example, various pieces of information measured by the sensor units 13 and 24 of the control device 1 and the flight vehicle 2 are collectively transmitted to the communication satellite 3, and the enormous amount of information is collectively transmitted to a ground station together with information on the satellite sensing conditions, so that it is possible to create 3D mapping information with high data reliability in which specific sensor information obtained by combining satellite data, above-water data, and marine data is reflected.

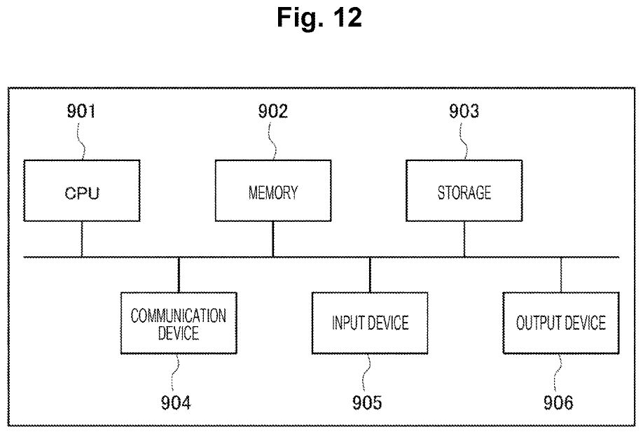

As the control unit 16 and the communication unit 15 of the control device 1 described above, for example, a general-purpose computer system as illustrated in FIG. 12 can be used. The illustrated computer system includes a central processing unit (CPU, processor) 901, a memory 902, a storage 903, a communication device 904, an input device 905, and an output device 906. The memory 902 and the storage 903 are storage devices. In the computer system, each function of the control unit 16 and the communication unit 15 is implemented by the CPU 901 executing a program of the control unit 16 and the communication unit 15 loaded on the memory 902.

The program for the control unit 16 and the communication unit 15 can be stored in a computer-readable recording medium such as a hard disk drive (HDD), a solid state drive (SSD), a universal serial bus (USB) memory, a compact disc (CD), or a digital versatile disc (DVD), or can be distributed via a network.

Note that the present invention is not limited to the above embodiment, and various modifications can be made within the scope of the gist of the present invention.

Reference Signs List

| | |
|---|---|
| 1 | Control device |
| 11 | Power generation unit |
| 111 | Solar power generation unit |
| 112 | Oscillating power generation unit |
| 12 | Power storage unit |
| 13 | Sensor unit (first measurement unit) |
| 14 | Power feeding unit |
| 141 | Wireless power feeding unit |
| 142 | Noncontact power feeding unit |
| 15 | Communication unit (first communication unit) |
| 16 | Control unit |
| 2 | Flight vehicle |
| 21 | Communication unit (second communication unit) |
| 22 | Power receiving unit |
| 23 | Adjustment unit |
| 24 | Sensor unit (second measurement unit) |
| 25 | Processing unit |
| 3 | Communication satellite |
| 4 | Wire |

1. A marine monitoring system comprising a control device and at least one flight vehicle, wherein:
the control device includes:
a first measurement unit, including one or more sensors, configured to measure at least one of data related to an underwater environment and data related to a sea-surface environment to acquire first measurement data,
a control unit, implemented using one or more computing devices, configured to control the at least one flight vehicle, and
a first communication unit, implemented using one or more computing devices, configured to receive second measurement data measured by the at least one flight vehicle; and
the flight vehicle includes:
a second measurement unit, including one or more sensors, configured to measure data related to an above-water environment based on control of the control device to acquire the second measurement data, and
a second communication unit, implemented using one or more computing devices, configured to transmit the second measurement data to the control device.

2. The marine monitoring system according to claim 1, wherein the first communication unit is configured to transmit, to a communication satellite, the first measurement data and the second measurement data received from the at least one flight vehicle.

3. The marine monitoring system according to claim 1, wherein:
the control device and the at least one flight vehicle are connected by a wire;
the control device or the at least one flight vehicle includes an adjustment unit, implemented using one or more computing devices, configured to adjust a length of an open portion of the wire; and
the control unit is configured to control the adjustment unit to shorten the length of the open portion of the wire to recover the at least one flight vehicle to the control device.

4. The marine monitoring system according to claim 1, wherein the control device includes;
a power feeding unit, implemented using one or more computing devices, configured to supply power to (i) a mobile flight vehicle among the at least one flight vehicle through radio wave transmission and (ii) a standby flight vehicle among the at least one flight vehicle through a contactless method within the control device.

5. The marine monitoring system according to claim 4, wherein the control device includes:
a solar power generator, and
an oscillatory power generator configured to use oscillation of waves.

6. A control device in a marine monitoring system including a control device and at least one flight vehicle, the control device comprising:
a measurement unit, including one or more sensors, configured to measure at least one of data related to an underwater environment and data related to a sea-surface environment to acquire first measurement data;
a control unit, implemented using one or more computing devices, configured to control the at least one flight vehicle, the at least one flight vehicle being configured to measure data related to an above-water environment; and
a communication unit, implemented using one or more computing devices, configured to receive second measurement data measured by the at least one flight vehicle.

7. A marine monitoring method performed by a marine monitoring system including a control device and at least one flight vehicle, the method comprising:
measuring, by the control device, at least one of data related to an underwater environment and data related to a sea-surface environment to acquire first measurement data;
controlling, by the control device, the at least one flight vehicle;
receiving, by the control device, second measurement data measured by the at least one flight vehicle;
measuring, by the at least one flight vehicle, data related to an above-water environment based on control of the control device to acquire the second measurement data; and
transmitting, by the at least one flight vehicle, the second measurement data to the control device.
